(19) United States
(12) Patent Application Publication
(10) Pub. No.: US 2024/0176167 A1
(43) Pub. Date: May 30, 2024

(54) INTEGRATED OPTICAL PHASE CHANGE MATERIALS FOR RECONFIGURABLE OPTICS IN GLASS CORES

(71) Applicant: Intel Corporation, Santa Clara, CA (US)

(72) Inventors: Benjamin DUONG, Phoenix, AZ (US); Kristof DARMAWIKARTA, Chandler, AZ (US); Tolga ACIKALIN, San Jose, CA (US); Harel FRISH, Albuquerque, NM (US); Sandeep GAAN, Chandler, AZ (US); John HECK, Berkeley, CA (US); Eric J. M. MORET, Beaverton, OR (US); Suddhasattwa NAD, Chandler, AZ (US); Haisheng RONG, Pleasanton, CA (US)

(21) Appl. No.: 18/071,246

(22) Filed: Nov. 29, 2022

(51) Int. Cl. G02F 1/01; G02B 6/125

(52) U.S. Cl. CPC G02F 1/0113; G02B 6/125; G02F 1/0147; G02B 2006/12145

(57) ABSTRACT

Embodiments disclosed herein include a package substrate. In an embodiment, the package substrate comprises a core where the core comprises glass. In an embodiment, the package substrate further comprises an optical waveguide over the core, and an optical phase change material over the optical waveguide.

### TECHNICAL FIELD

Embodiments of the present disclosure relate to electronic packages, and more particularly to package substrates with glass cores with optical routing that is reconfigurable due to the presence of optical phase change materials.

### BACKGROUND

Advanced electronic packages are moving toward the use of optical interconnects. That is, optical waveguides are used in order to route signals between components on a package substrate and/or between on-package components and external components. In order to improve optical routing, optical switches may be necessary. The optical switches can be in an on-configuration or an off-configuration. In the on-configuration, optical signals can pass through, whereas in the off-configuration the optical signals are blocked. Such switching architectures can be used in order to switch the signals. For example, a signal from a light source may originally be sent to a first component. One or more switches can be switched (e.g., on-to-off and/or off-to-on) in order to switch the path to be from the light source to a second component. Such an architecture may be referred to as a reconfigurable optics system.

Existing optical switching architectures, such as heaters, require static power in order to maintain the state of the switch. For example, power may need to be continuously supplied to keep the switch in the on-configuration. When power is released, the optical switch may revert to the off-configuration. Accordingly, existing reconfigurable optics systems are limited by high power consumption.

### BRIEF DESCRIPTION OF THE DRAWINGS

FIG. 1A is a cross-sectional illustration of an optical switch that includes optical phase change material (oPCM) that is controlled by an optical signal, in accordance with an embodiment.

FIG. 1B is a cross-sectional illustration of an optical switch that includes oPCM that is controlled by applying heat, in accordance with an embodiment.

FIG. 1C is a cross-sectional illustration of an optical switch that includes oPCM that is controlled by applying an electric field, in accordance with an embodiment.

FIG. 2A is a cross-sectional illustration of an optical switch that includes oPCM on sidewall surfaces of the optical waveguide, in accordance with an embodiment.

FIG. 2B is a cross-sectional illustration of an optical switch that includes oPCM on a top surface of the optical waveguide, in accordance with an embodiment.

FIG. 3A is a cross-sectional illustration of an optical switch that includes oPCM with electrodes only over sidewalls of the optical waveguide, in accordance with an embodiment.

FIG. 3B is a cross-sectional illustration of an optical switch that includes oPCM with a resistive heater over the top surface of the optical waveguide, in accordance with an embodiment.

FIGS. 4A-4G are cross-sectional illustrations depicting a process for forming a package substrate with an optical switch comprising oPCM over an optical waveguide, in accordance with an embodiment.

FIG. 5 is a plan view illustration of an electronic package with optical switching circuitry between components, in accordance with an embodiment.

FIG. 6A is a schematic of an electronic package with optical switching circuitry in order to route optical signals between photonics integrated circuits (PICs), in accordance with an embodiment.

FIG. 6B is a schematic of an electronic package with optical switching circuitry in order to route optical signals between two different external devices, in accordance with an embodiment.

FIG. 6C is a schematic of an electronic package with optical switching circuitry in order to route optical signals from an external device to two different PICs, in accordance with an embodiment.

FIG. 7 is a cross-sectional illustration of an electronic system that includes a plurality of optical waveguides that are controlled by optical switches that comprise oPCM, in accordance with an embodiment.

FIG. 8 is a schematic of a computing device built in accordance with an embodiment.

### EMBODIMENTS OF THE PRESENT DISCLOSURE

Described herein are package substrates with glass cores with optical routing that is reconfigurable due to the presence of optical phase change materials, in accordance with various embodiments. In the following description, various aspects of the illustrative implementations will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative implementations. However, it will be apparent to one skilled in the art that the present invention may be practiced without the specific details. In other instances, well-known features are omitted or simplified in order not to obscure the illustrative implementations.

Various operations will be described as multiple discrete operations, in turn, in a manner that is most helpful in understanding the present invention, however, the order of description should not be construed to imply that these operations are necessarily order dependent. In particular, these operations need not be performed in the order of presentation.

As noted above, reconfigurable optics systems are of growing importance in electronic packaging. As used herein, a “reconfigurable optics system” may refer to a system that transmits optical signals where the optical signal can be routed to two or more different destinations. Reconfigurable optics systems may be beneficial for redundancy applications (e.g., having a backup laser source in case the main laser source malfunctions or is defective) or for traditional switching to transmit signals between different components on (or off) of a package substrate.

However, existing solutions for reconfigurable optics systems require constant power in order to maintain the state of the optical switches. For example, resistive heaters may be used in order to activate a switch. A first state of operation may occur when the heater is off, and the second state may occur when the heater is on. As such, operating the switch in the second state may require constant heater power, and is, therefore, a significant power draw for the system.

Accordingly, embodiments disclosed herein include optical switches that are operated without a constant power draw. Instead power can be applied (e.g., through an optical signal, application of thermal energy, or application of an electric field) in order to change the state of the optical switch. After the state is changed, there is no further need for power to be applied. Particularly, embodiments disclosed herein may utilize optical phase change material (oPCM) in order to operate the optical switches. oPCM exists in two states: 1) amorphous; and 2) crystalline. When in the amorphous state, the switch may operate as closed. When in the crystalline state, the switch may operate as open.

oPCM material may include any material structure that undergoes a phase change using light pulses, heat, or electric field. Embodiments also include materials that are capable of undergoing repeated changes in structure in order to provide switching back and forth between states. In one embodiment, oPCMs may include germanium, antimony, and tellurium (GST). In other embodiments, oPCM may include germanium, antimony, selenium, and tellurium (GSST). In yet another embodiment, oPCM may include antimony and sulfur. Embodiments may also include antimony and selenium. While specific examples of oPCMs are provided herein, it is to be appreciated that other suitable oPCM materials may also be used in accordance with embodiments disclosed herein.

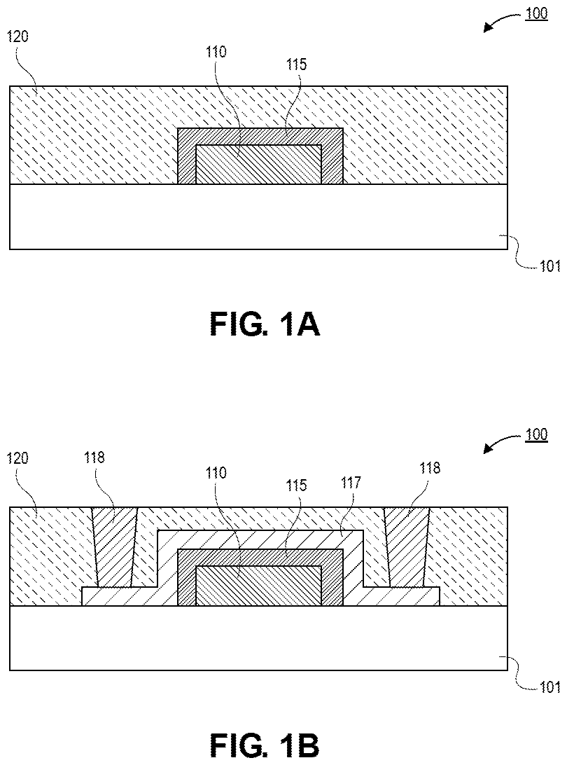

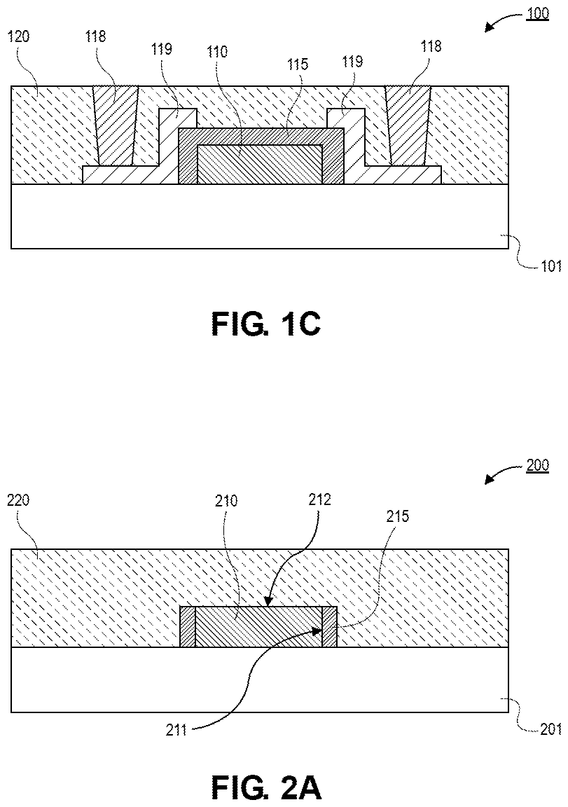

Referring now to FIG. 1A, a cross-sectional illustration of a portion of a package substrate 100 is shown, in accordance with an embodiment. In an embodiment, the package substrate 100 may comprise a core 101. The core 101 may be a glass core in some embodiments. For example, the core 101 may be a borosilicate glass or a fused silica glass. Though, other glass materials may also be used in other embodiments. In a certain embodiment, the glass core 101 may be a material that is capable of undergoing a laser assisted patterning process. In such an embodiment, through glass vias (TGVs) (not shown) may be formed through the core 101 by: 1) exposing the glass to a laser; 2) etching the exposed regions; and 3) plating a conductive material in the openings. In an embodiment, the core 101 may have a thickness that is up to approximately 1,000 μm. Though thicker cores 101 may also be used. As used herein, “approximately” refers to a range of values that are within ten percent of the stated value. For example, approximately 1,000 μm may refer to a range between 900 μm and 1,100 μm.

In an embodiment, an optical waveguide 110 may be provided over the core 101. The optical waveguide 110 may be any material (or materials) that enables total internal reflection in order to propagate optical signals. In the illustrated embodiment, the optical waveguide 110 is oriented so that the direction of signal propagation is into and out of the plane of FIG. 1A. In an embodiment, the optical waveguide 110 may comprise silicon and nitrogen (e.g., SiN), though other materials may be used in some embodiments. Particularly, the embodiment shown in FIG. 1A has an optical waveguide 110 that is a different material than the core 101.

In an embodiment, an oPCM 115 may be provided on the optical waveguide 110. The oPCM 115 may be provided along sidewalls and a top surface of the optical waveguide 110. That is, three of the four sides of the optical waveguide 110 may be directly contacted by the oPCM 115. The oPCM 115 may have a thickness that is between approximately 1 nm and approximately 1 μm. Though, thinner or thicker oPCM 115 layers may also be used in some embodiments. In an embodiment, an encapsulation layer 120 may be provided over the core 101 and the oPCM 115. The encapsulation layer 120 may include silicon and oxygen (e.g., SiO₂) or any other suitable materials. For example, buildup film material typically used in electronic packaging applications may be provided as the encapsulation layer 120. In some embodiments, the encapsulation layer 120 may also be used as an optical cladding for confining the optical signal within the optical waveguide 110. After formation of the oPCM 115 and the encapsulation layer 120, traditional electronic packaging processes may be used in order to finish assembly of the package substrate 100.

In the embodiment shown in FIG. 1A, the oPCM 115 may be controlled by supplying one or more optical pulses through the optical waveguide 110. The optical pulses may generally be of higher intensity than the optical signals that are passed through the optical waveguide 110. As such, when the oPCM 115 is desired to switch states, the high intensity pulse (or pulses) can be provided through the optical waveguide 110.

Referring now to FIG. 1B, a cross-sectional illustration of a portion of a package substrate 100 is shown, in accordance with an additional embodiment. In an embodiment, the package substrate 100 in FIG. 1B may be substantially similar to the package substrate 100 in FIG. 1A, with the exception of the switching architecture. That is, the package substrate 100 may include a core 101 with an optical waveguide 110 over the core 101. An oPCM 115 may be provided around the optical waveguide 110, and an encapsulation layer 120 may be provided over the oPCM 115 and the core 101.

However, instead of using an optical signal for switching the oPCM 115, thermal energy is applied to the oPCM 115 in order to switch states. The thermal energy is supplied by a resistive heating element 117. The resistive heating element 117 may comprise titanium and nitrogen (e.g., TiN), tantalum and nitrogen (e.g., TaN), indium, tin, and oxygen (ITO), or any other electrically conductive material. In an embodiment contacts 118 may be provided on opposite sides of the resistive heating element 117. The resistive heating element 117 may be provided along sidewalls and a top surface of the oPCM 115. Pads on the core 101 may also be provided in order to receive the contacts 118.

Referring now to FIG. 1C, a cross-sectional illustration of a portion of a package substrate 100 is shown, in accordance with an embodiment. In an embodiment, the package substrate 100 in FIG. 1C is substantially similar to the electronic package 100 in FIG. 1B with the exception of the switching architecture. That is, the package substrate 100 may include a core 101 with an optical waveguide 110 over the core 101. An oPCM 115 may be provided around the optical waveguide 110, and an encapsulation layer 120 may be provided over the oPCM 115 and the core 101.

However, instead of using resistive heating, the embodiment uses an electric field in order to switch the state of the oPCM 115. In an embodiment, the package substrate 100 may include electrodes 119 on opposite sides of the oPCM 115. The electrodes 119 may be contacted by electrical contacts 118. The electrodes 119 may wrap around the sides and top surface of the oPCM 115. Instead of contacting each other, the electrodes 119 have a gap between them. The gap allows for the electrodes 119 to be electrically isolated from each other in order to be held at different voltages in order to induce an electric field that alters the state of the oPCM 115.

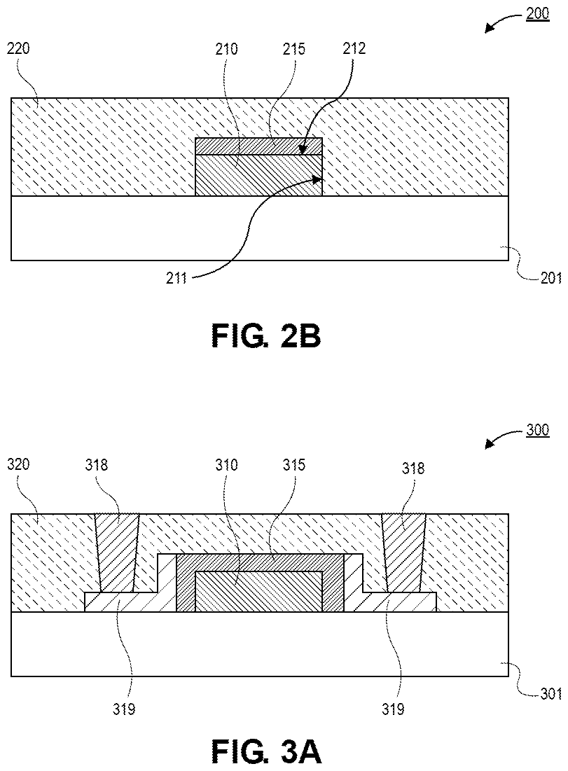

In FIGS. 1A-1C, the oPCM 115 wraps entirely around the optical waveguide 110. That is, the oPCM 115 is on the sidewall surfaces and the top surface of the optical waveguide 110. However, it is to be appreciated that the oPCM 115 need not be provided over all surfaces of the optical waveguide 110 in some embodiments. For example, FIGS. 2A and 2B show alternative architectures where the oPCM 215 is only over portions of the optical waveguide 210.

Referring now to FIG. 2A, a cross-sectional illustration of a portion of a package substrate 200 is shown, in accordance with an embodiment. In an embodiment, the package substrate 200 comprises a core 201. The core 201 may be a glass core 201. The glass material may be similar to any of the glass substrates described in greater detail above. In an embodiment, an optical waveguide 210 may be provided over the core 201. The optical waveguide 210 may comprise silicon and nitrogen in some embodiments. In an embodiment, the optical waveguide 210 may include sidewall surfaces 211 and a top surface 212.

In an embodiment, an oPCM 215 is provided on the optical waveguide 210. In contrast to the embodiments described above, the oPCM 215 may only be provided over portions of the optical waveguide 210. For example, in the embodiment shown in FIG. 2A, the oPCM 215 is provided only on the sidewall surfaces 211 of the optical waveguide 210. The oPCM 215 may also be provided along a single sidewall surface 211. In an embodiment, the oPCM 215 in FIG. 2A may be switched between states using an optical pulsing process. That is, there may not be a need for contacts or heaters in order to switch the state of the oPCM 215.

In an embodiment, an encapsulation layer 220 may be provided over the core 201 and the oPCM 215. Additionally, since the top surface 212 is exposed, the encapsulation layer 220 may directly contact portions of the optical waveguide 210. The encapsulation layer 220 may comprise silicon and oxygen or any material suitable for encapsulation layers described in greater detail above.

Referring now to FIG. 2B, a cross-sectional illustration of a portion of a package substrate 200 is shown, in accordance with an additional embodiment. In an embodiment, the package substrate 200 in FIG. 2B may be substantially similar to the package substrate 200 in FIG. 2A, with the exception of the oPCM 215. That is, the package substrate 200 may comprise a core 201, an optical waveguide 210, and an encapsulation layer 220. However, instead of being formed over the sidewalls 211, the oPCM 215 is provided over the top surface 212 of the optical waveguide 210. The oPCM 215 in FIG. 2B may also be switched using light pulses, and there is no need for electrical contacts. Since the sidewalls 211 are exposed, the encapsulation layer 220 may directly contact the sidewalls of the optical waveguide 210.

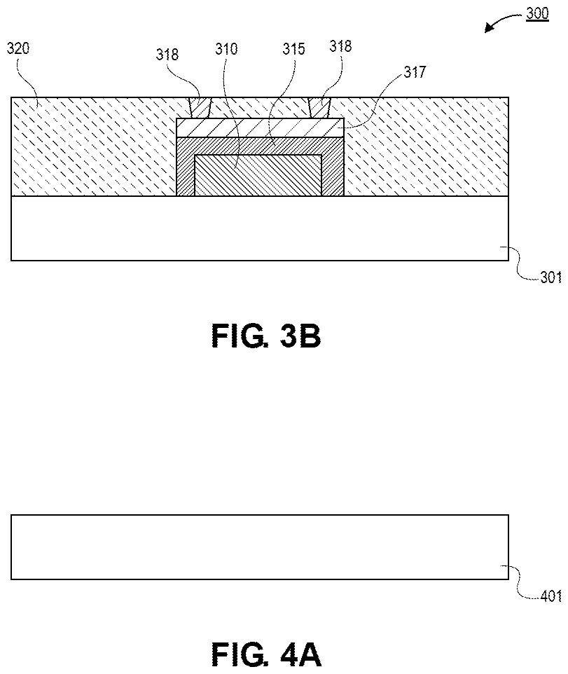

Referring now to FIGS. 3A and 3B, alternative embodiments that include electric field switching (FIG. 3A) and resistive heating switching (FIG. 3B) are shown, in accordance with an additional embodiment. Particularly, the embodiments shown in FIGS. 3A and 3B include electrodes and heating elements that do not wrap entirely around the oPCM 315 as shown in the embodiments described above.

Referring now to FIG. 3A, a cross-sectional illustration of a portion of a package substrate 300 is shown, in accordance with an embodiment. In an embodiment, the package substrate 300 may comprise a core 301. The core 301 may be a glass core 301, similar to any of the glass substrate materials described in greater detail above. In an embodiment, an optical waveguide 310 is provided over the core 301. The optical waveguide 310 may comprise silicon and nitrogen or any other suitable optical waveguide 310 material. In an embodiment, an oPCM 315 is provided along sidewalls and a top surface of the optical waveguide 310. The oPCM 315 may be any suitable oPCM 315 material, such as those described in greater detail above.

In an embodiment, electrodes 319 may be provided in contact with the oPCM 315. However, instead of wrapping around the corner of the optical waveguide 310, the electrodes 319 may be only provided along sidewalls of the optical waveguide 310. That is, the pair of electrodes 319 may be provided on opposite sides of the optical waveguide 310. The electrodes 319 may each be contacted by contacts 318. The contacts 318 may land on pad portions of the electrodes 319 that are directly over the core 301. In an embodiment, an encapsulation layer 320 may be provided over the core 301, the oPCM 315 and the contacts 318.

Referring now to FIG. 3B, a cross-sectional illustration of a portion of a package substrate 300 is shown, in accordance with an additional embodiment. In an embodiment, the package substrate 300 comprises a core 301, such as a glass core 301. In an embodiment, an optical waveguide 310 is provided over the core 301. An oPCM 315 may be provided around the optical waveguide 310. In an embodiment, a resistive heating element 317 is provided over the top surface of the oPCM 315. The resistive heating element 317 may comprise titanium and nitrogen (e.g., TiN), tantalum and nitrogen (e.g., TaN), indium, tin, and oxygen (ITO), or the like. In an embodiment, contacts 318 are provided on opposite sides of the resistive heating element 317. As current is supplied through the resistive heating element 317, the resistive heating element increases in temperature. The increase in temperature switches the state of the oPCM 315. In an embodiment, the resistive heating element 317 is provided only over the top surface of the oPCM 315. That is sidewall surfaces of the oPCM 315 may be exposed. An encapsulation layer 320 may be provided over the core 301 and around the oPCM 315 in some embodiments.

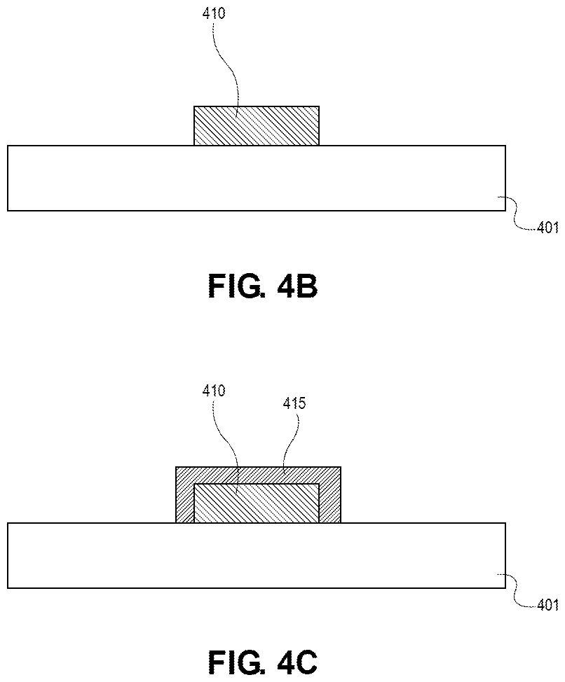

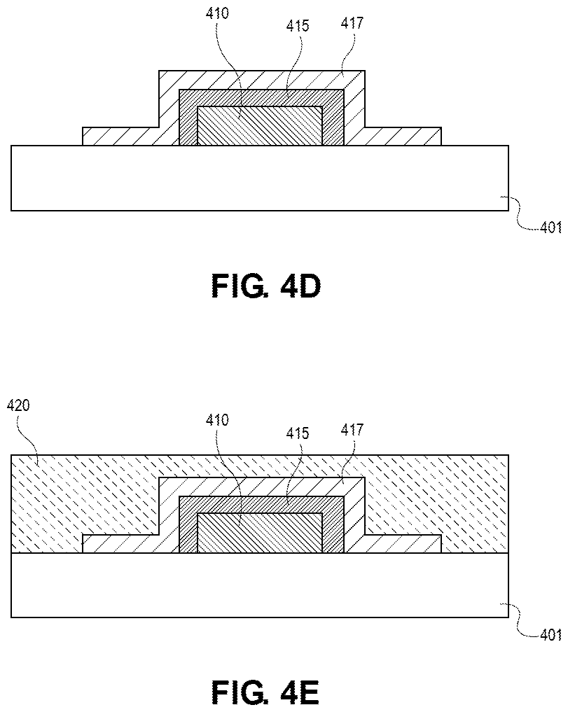

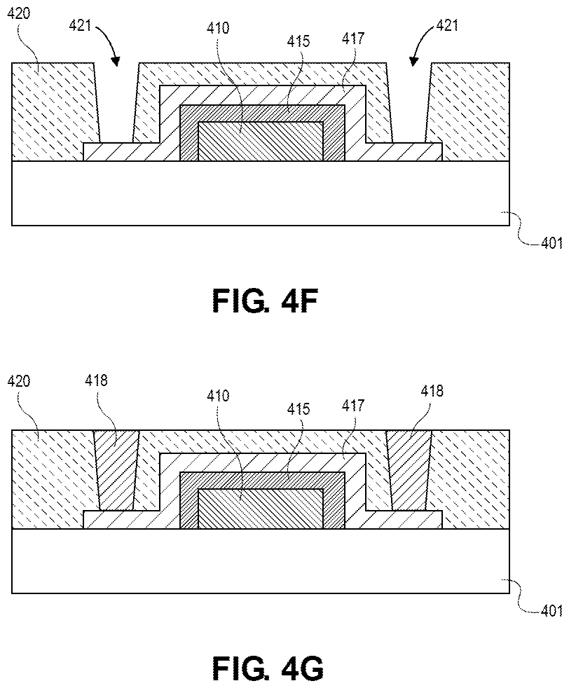

Referring now to FIGS. 4A-4G, a series of cross-sectional illustrations depicting a process for forming a package substrate with an optical switch over an optical waveguide is shown, in accordance with an embodiment. In the embodiment shown in FIGS. 4A-4G, a package substrate similar to the package substrate 100 in FIG. 1B is shown. However, it is to be appreciated that minor modifications may be made to the process flow in order to form package substrates similar to any of the package substrates described in greater detail herein.

Referring now to FIG. 4A, a cross-sectional illustration of a core 401 is shown, in accordance with an embodiment. In an embodiment, the core 401 may be a glass core 401. The glass material may be similar to any of the glass substrates described in greater detail above. The core 401 may have a thickness that is up to approximately 1,000 μm thick. Though, thicker cores 401 may also be used in some embodiments.

Referring now to FIG. 4B, a cross-sectional illustration of the core 401 after an optical waveguide 410 is formed over the core 401 is shown, in accordance with an embodiment. In an embodiment, the optical waveguide 410 may comprise silicon and nitrogen. The optical waveguide 410 may be formed with a blanket deposition and patterning process. For example, a layer comprising silicon and nitrogen may be deposited over the core 401, and a patterning process (e.g., lithography process) may be used in order to define the shape of the optical waveguide 410. The blanket deposition process may use physical vapor deposition (PVD), chemical vapor deposition (CVD), or the like.

Referring now to FIG. 4C, a cross-sectional illustration of the core 401 after an oPCM 415 is applied over the optical waveguide 410 is shown, in accordance with an embodiment. In an embodiment, the oPCM 415 may be deposited with a blanket deposition process and patterned. The blanket deposition process may include PVD, CVD, atomic layer deposition (ALD), physical layer deposition (PLD), or the like. In an embodiment, the blanket layer of the oPCM 415 may be patterned with any suitable patterning process (e.g., photolithography). In an embodiment, the oPCM 415 may be provided along sidewalls and a top surface of the optical waveguide 410. The oPCM 415 may be any of the oPCM materials described in greater detail above.

Referring now to FIG. 4D, a cross-sectional illustration of the core 401 after resistive heating element 417 is formed on the oPCM 415 is shown, in accordance with an embodiment. In an embodiment, the resistive heating element 417 may be provided along sidewalls of the oPCM 415 and a top surface of the oPCM 415. The resistive heating element 417 may also be provided along the top surface of the core 401. The portion of the resistive heating element 417 on the core 401 may be used as a pad onto which contacts are later attached. In an embodiment, the resistive heating element 417 may comprise titanium and nitrogen (e.g., TiN), tantalum and nitrogen (e.g., TaN), indium, tin, and oxygen (ITO), or any other electrically conductive material.

Referring now to FIG. 4E, a cross-sectional illustration of the core 401 after an encapsulation layer 420 is formed over the core 401 is shown, in accordance with an embodiment. In an embodiment, the encapsulation layer 420 may comprise silicon and oxygen (e.g., SiO₂). The encapsulation layer 420 may contact the core 401, the top surface of the oPCM 415 and the resistive heating element 417. The encapsulation layer 420 may be formed with any suitable process, such as PVD, CVD, or the like.

Referring now to FIG. 4F, a cross-sectional illustration of the core 401 after via openings 421 are formed in the encapsulation layer 420 is shown, in accordance with an embodiment. In an embodiment, the via openings 421 expose a pad portion of the resistive heating element 417 that is provided on the core 401. In an embodiment, the via openings 421 may have tapered sidewalls. That is, a top of the via openings 421 may be wider than a bottom of the via openings 421. The via openings 421 may be formed with any patterning process. For example, laser etching, dry etching, wet etching, or the like may be used in order to form the via openings 421.

Referring now to FIG. 4G, a cross-sectional illustration of the core 401 after contacts 418 fill the via openings 421 is shown, in accordance with an embodiment. In an embodiment, the contacts 418 may be plated with a plating process, such as electrolytic plating, electroless plating, or the like. In other embodiments, a deposition process (e.g., PVD, CVD, etc.) may be used to form the contacts 418. In an embodiment, the contacts 418 may be any suitable electrically conductive material. For example, the contacts 418 may comprise copper, aluminum, tungsten, cobalt, silver, gold, any combination thereof, or the like.

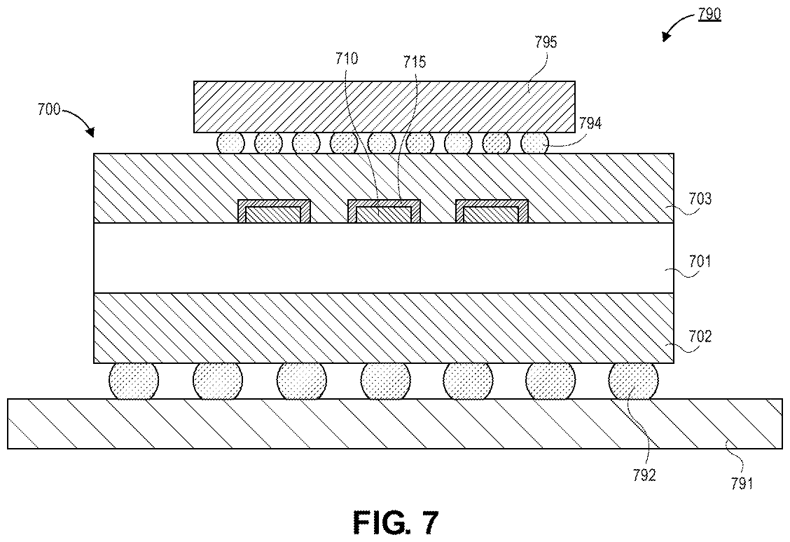

After the formation of the contacts 418, processing may continue using traditional packaging assembly processes. For example, one or more buildup layers (e.g., comprising buildup film, electrical features, etc.) can be formed over the encapsulation layer 420. An example of a fully finished package substrate is provided in greater detail below with respect to FIG. 7.

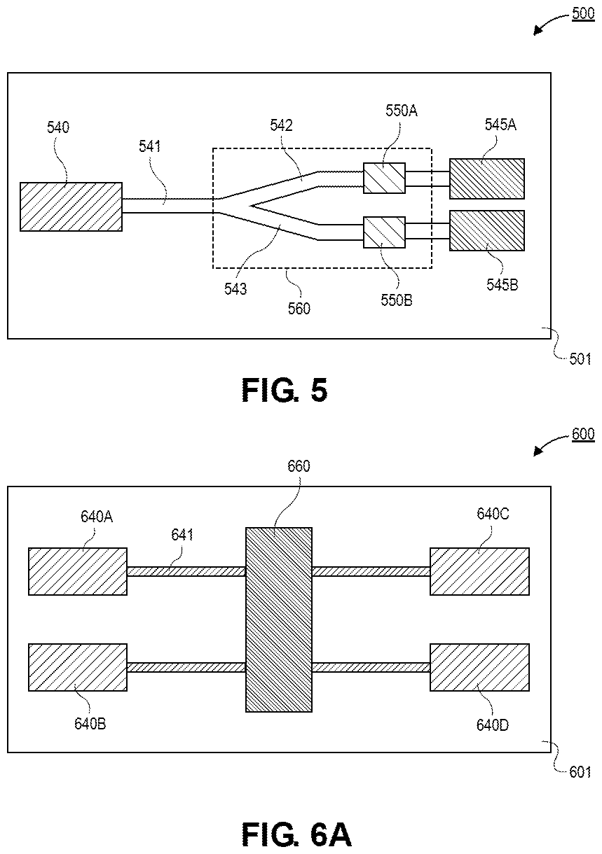

Referring now to FIG. 5, an example of a reconfigurable optics system 560 on a package substrate 500 is shown, in accordance with an embodiment. In an embodiment, the package substrate 500 may comprise a core 501. In an embodiment, a photonics integrated circuit (PIC) 540 may be provided over the core 501. In an embodiment, the PIC 540 may be optically coupled to a first component 545A and a second component 545B. A reconfigurable optics system 560 may be provided between the PIC 540 and the first component 545A and the second component 545B.

In an embodiment, an optical waveguide 541 extends out from the PIC 540. Within the reconfigurable optics system 560, the optical waveguide 541 branches into a first branch 542 and a second branch 543. The first branch 542 may be controlled by first oPCM 550A, and the second branch 543 may be controlled by second oPCM 550B. That is, the oPCMs 550 may be switched between an on-state and an off-state in order to control the propagation of optical signals. For example, the first oPCM 550A may be on to allow optical signals to propagate to the first component 545A, and the second oPCM 550B may be off to block optical signals from propagating to the second component 545B. The alternative configuration (i.e., first oPCM 550A off and second oPCM 550B on) can be used to propagate signals to only the second component 545B. In an embodiment, the oPCMs 550A and 550B may be similar to any of the optical switches described in greater detail herein. While a pair of oPCM 550 switches are shown in FIG. 5, it is to be appreciated that any number of oPCM 550 switches that allow for routing to any number of components 545 may be used in embodiments described herein.

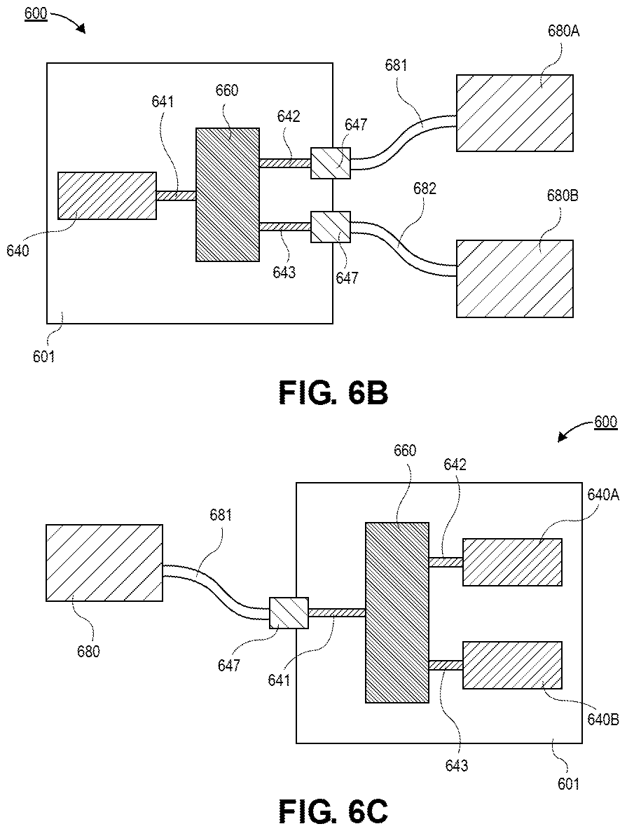

Referring now to FIG. 6A, a plan view illustration of a package substrate 600 with a plurality of PICs 640A-640D is shown, in accordance with an embodiment. As shown, the PICs 640A-640D may be optically coupled to each other through the reconfigurable optics system 660 formed over the core 601. As shown, each PIC 640 may be optically coupled to the reconfigurable optics system 660 by optical waveguides 641. The reconfigurable optics system 660 may include a set of optical switches using oPCM (not shown). The optical switches can be configured in order to allow any of the PICS 640 to be optically coupled to each other.

Referring now to FIG. 6B, a plan view illustration of a package substrate 600 that is optically coupled to a pair of external components 680A and 680B is shown, in accordance with an embodiment. In an embodiment, the package substrate 600 comprises a core 601. A PIC 640 may be provided over the core 601. The PIC 640 may be optically coupled to a reconfigurable optics system 660 by an optical waveguide 641. The reconfigurable optics system 660 may include oPCM optical switches (not shown) that allow for optical signals to be propagated to either a first optical waveguide 642 or a second optical waveguide 643. The optical waveguides 642 and 643 may be coupled to optical fibers 681 and 682 through fiber connectors 647. The optical fibers 681 and 682 may be optically coupled to external components 680A and 680B. As such, the reconfigurable optics system 660 allows for the PIC 640 to communicate with either of the external components 680A and 680B.

Referring now to FIG. 6C, a plan view illustration of a package substrate 600 that includes a single external component 680 that is optically coupled to a pair of PICs 640A and 640B is shown, in accordance with an embodiment. As shown, the external component 680 is coupled to an optical waveguide 641 through an optical fiber 681 and an fiber connector 647. The optical waveguide 641 may be coupled to a reconfigurable optics system 660. The reconfigurable optics system 660 may include two or more optical switches (not shown) that are formed with oPCM (not shown). The optical switches control propagation of the optical signal to either optical waveguide 642 that is coupled to PIC 640A or optical waveguide 643 that is coupled to PIC 640B. As such, a single external component 680 may be optically coupled to two or more different PICs 640.

Referring now to FIG. 7, a cross-sectional illustration of an electronic system 790 is shown, in accordance with an embodiment. In an embodiment, the electronic system 790 comprises a board 791, such as a printed circuit board (PCB). The board 791 may be coupled to a package substrate 700 by interconnects 792. While shown as solder interconnects 792, it is to be appreciated that interconnects 792 may include any interconnect architecture.

In an embodiment, the package substrate 700 comprises a core 701. In an embodiment, buildup layers 702 and 703 may be provided above and below the core 701. The buildup layers may comprises conductive features (not shown) such as pads, traces, vias, and the like. In an embodiment, one or more optical waveguides 710 may be provided over the core 701. The optical waveguides 710 may be controlled by optical switches that are formed from oPCM 715 that is in contact with the optical waveguides 710. In the illustrated embodiment, the oPCM 715 is controlled by optical pulses. Though, it is to be appreciated that electric field or resistive heating embodiments may also be used. More generally, any of the oPCM architectures described herein may be used as an optical switch for the optical waveguides 710.

In an embodiment, a die 795 may be coupled to the package substrate 700. The die 795 may be coupled to the package substrate 700 through interconnects 794. The interconnects 794 may be any first level interconnect (FLI) architecture. The die 795 may be a compute die, a memory die, or any type of die. Additionally, multiple dies 795 may be used in some embodiments.

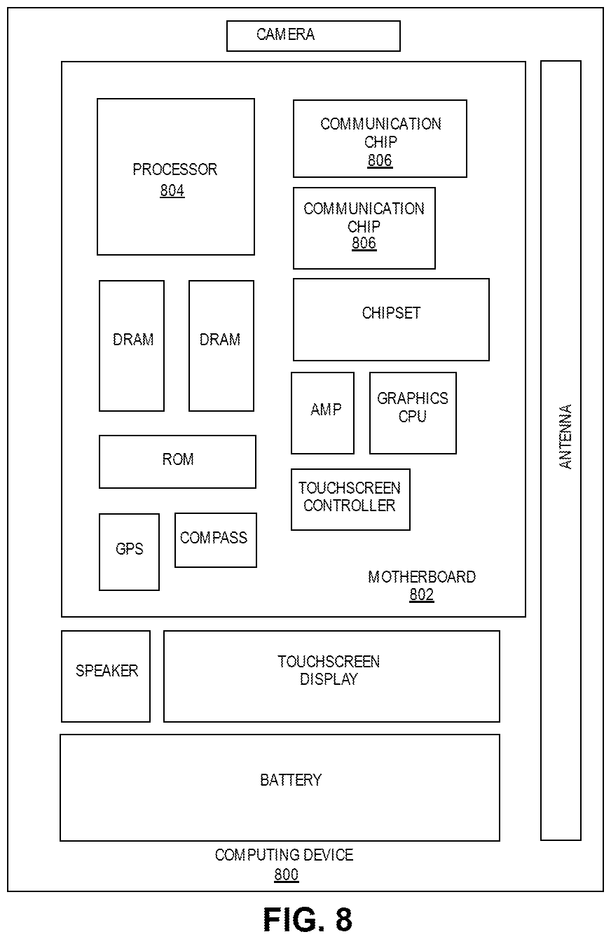

FIG. 8 illustrates a computing device 800 in accordance with one implementation of the invention. The computing device 800 houses a board 802. The board 802 may include a number of components, including but not limited to a processor 804 and at least one communication chip 806. The processor 804 is physically and electrically coupled to the board 802. In some implementations the at least one communication chip 806 is also physically and electrically coupled to the board 802. In further implementations, the communication chip 806 is part of the processor 804.

These other components include, but are not limited to, volatile memory (e.g., DRAM), non-volatile memory (e.g., ROM), flash memory, a graphics processor, a digital signal processor, a crypto processor, a chipset, an antenna, a display, a touchscreen display, a touchscreen controller, a battery, an audio codec, a video codec, a power amplifier, a global positioning system (GPS) device, a compass, an accelerometer, a gyroscope, a speaker, a camera, and a mass storage device (such as hard disk drive, compact disk (CD), digital versatile disk (DVD), and so forth).

The communication chip 806 enables wireless communications for the transfer of data to and from the computing device 800. The term “wireless” and its derivatives may be used to describe circuits, devices, systems, methods, techniques, communications channels, etc., that may communicate data through the use of modulated electromagnetic radiation through a non-solid medium. The term does not imply that the associated devices do not contain any wires, although in some embodiments they might not. The communication chip 806 may implement any of a number of wireless standards or protocols, including but not limited to Wi-Fi (IEEE 802.11 family), WiMAX (IEEE 802.16 family), IEEE 802.20, long term evolution (LTE), Ev-DO, HSPA+, HSDPA+, HSUPA+, EDGE, GSM, GPRS, CDMA, TDMA, DECT, Bluetooth, derivatives thereof, as well as any other wireless protocols that are designated as 3G, 4G, 5G, and beyond. The computing device 800 may include a plurality of communication chips 806. For instance, a first communication chip 806 may be dedicated to shorter range wireless communications such as Wi-Fi and Bluetooth and a second communication chip 806 may be dedicated to longer range wireless communications such as GPS, EDGE, GPRS, CDMA, WiMAX, LTE, Ev-DO, and others.

The processor 804 of the computing device 800 includes an integrated circuit die packaged within the processor 804. In some implementations of the invention, the integrated circuit die of the processor may be part of an electronic package that comprises a glass core with optical waveguides that are controlled by oPCM optical switches, in accordance with embodiments described herein. The term “processor” may refer to any device or portion of a device that processes electronic data from registers and/or memory to transform that electronic data into other electronic data that may be stored in registers and/or memory.

The communication chip 806 also includes an integrated circuit die packaged within the communication chip 806. In accordance with another implementation of the invention, the integrated circuit die of the communication chip may be part of an electronic package that comprises a glass core with optical waveguides that are controlled by oPCM optical switches, in accordance with embodiments described herein.

The above description of illustrated implementations of the invention, including what is described in the Abstract, is not intended to be exhaustive or to limit the invention to the precise forms disclosed. While specific implementations of, and examples for, the invention are described herein for illustrative purposes, various equivalent modifications are possible within the scope of the invention, as those skilled in the relevant art will recognize.

These modifications may be made to the invention in light of the above detailed description. The terms used in the following claims should not be construed to limit the invention to the specific implementations disclosed in the specification and the claims. Rather, the scope of the invention is to be determined entirely by the following claims, which are to be construed in accordance with established doctrines of claim interpretation.

Example 1: a package substrate, comprising: a core, wherein the core comprises glass; an optical waveguide over the core; and an optical phase change material over the optical waveguide.

Example 2: the package substrate of Example 1, wherein the optical phase change material is over three surfaces of the optical waveguide.

Example 3: the package substrate of Example 1, wherein the optical phase change material is over a single surface of the optical waveguide.

Example 4: the package substrate of Examples 1-3, wherein the optical phase change material is over sidewalls of the optical waveguide.

Example 5: the package substrate of Examples 1-4, wherein the optical phase change material is configured to be switched between an on state and an off state with an optical pulse.

Example 6: the package substrate of Examples 1-5, wherein the optical phase change material is configured to be switched between an on state and an off state by applying thermal energy to the optical phase change material.

Example 7: the package substrate of Example 6, wherein a resistive heater is provided over the optical phase change material.

Example 8: the package substrate of Examples 1-5, wherein the optical phase change material is configured to be switched between an on state and an off state by applying an electrical field to the optical phase change material.

Example 9: the package substrate of Example 8, further comprising: a first electrode on a first end of the optical phase change material, and a second electrode on a second end of the optical phase change material.

Example 10: the package substrate of Examples 1-9, wherein the optical phase change material comprises germanium, antimony, and tellurium, or germanium, antimony, selenium, and tellurium, or antimony and sulfur, or antimony and selenium.

Example 11: an optical communication system, comprising: a first photonics integrated circuit (PIC); a second PIC; an optical waveguide to optically couple the first PIC to the second PIC; and an optical switch on the optical waveguide between the first PIC and the second PIC, wherein the optical switch comprises an optical phase change material.

Example 12: the optical communication system of Example 11, further comprising: a third PIC, wherein the third PIC is communicatively coupled to the first PIC and the second PIC.

Example 13: the optical communication system of Example 12, further comprising: a second optical switch between the third PIC and the first PIC, wherein the second optical switch comprises an optical phase change material.

Example 14: the optical communication system of Example 13, wherein the optical switch and the second optical switch are configured to be in opposite states.

Example 15: the optical communication system of Examples 11-14, wherein the optical switch is over at least one surface of the optical waveguide.

Example 16: the optical communication system of Examples 11-14, wherein the optical switch is over at least two surfaces of the optical waveguide.

Example 17: the optical communication system of Examples 11-16, wherein the optical switch is switched between an on state and an off state using an optical signal, applying thermal energy to the optical phase change material, or applying an electric field to the optical phase change material.

Example 18: the optical communication system of Examples 11-17, wherein the optical waveguide is over a glass substrate.

Example 19: the optical communication system of Examples 11-18, wherein the optical communication system is part of an electronic package.

Example 20: an electronic package, comprising: a core, wherein the core comprises glass; an optical waveguide provided on the core, wherein the optical waveguide has a first branch and a second branch; a first optical switch on the first branch and a second optical switch on the second branch, wherein the optical switches each comprise: an optical phase change material that is in direct contact with the optical waveguide; a first component at a first end of the optical waveguide; a second component at a second end of the optical waveguide along the first branch; and a third component at the second end of the optical waveguide along the second branch.

Example 21: the electronic package of Example 20, wherein the first component is a photonics integrated circuit (PIC).

Example 22: the electronic package of Example 20 or Example 21, wherein the electronic package is coupled to a board, and wherein a die is coupled to the electronic package.

Example 23: a computing system, comprising: a board; a package substrate coupled to the board, wherein the package substrate comprises: a core, wherein the core comprises glass; an optical waveguide network on the core; and an optical switch on the optical waveguide network, wherein the optical switch comprises an optical phase change material; and a die coupled to the package substrate.

Example 24: the computing system of Example 23, wherein the die comprises a photonics integrated circuit (PIC).

Example 25: the computing system of Example 23 or Example 24, wherein the optical phase change material comprises germanium, antimony, and tellurium, or germanium, antimony, selenium, and tellurium, or antimony and sulfur, or antimony and selenium.

What is claimed is:

1. A package substrate, comprising:
a core, wherein the core comprises glass;
an optical waveguide over the core; and
an optical phase change material over the optical waveguide.

2. The package substrate of claim 1, wherein the optical phase change material is over three surfaces of the optical waveguide.

3. The package substrate of claim 1, wherein the optical phase change material is over a single surface of the optical waveguide.

4. The package substrate of claim 1, wherein the optical phase change material is over sidewalls of the optical waveguide.

5. The package substrate of claim 1, wherein the optical phase change material is configured to be switched between an on state and an off state with an optical pulse.

6. The package substrate of claim 1, wherein the optical phase change material is configured to be switched between an on state and an off state by applying thermal energy to the optical phase change material.

7. The package substrate of claim 6, wherein a resistive heater is provided over the optical phase change material.

8. The package substrate of claim 1, wherein the optical phase change material is configured to be switched between an on state and an off state by applying an electrical field to the optical phase change material.

9. The package substrate of claim 8, further comprising:
a first electrode on a first end of the optical phase change material, and a second electrode on a second end of the optical phase change material.

10. The package substrate of claim 1, wherein the optical phase change material comprises germanium, antimony, and tellurium, or germanium, antimony, selenium, and tellurium, or antimony and sulfur, or antimony and selenium.

11. An optical communication system, comprising:
a first photonics integrated circuit (PIC);
a second PIC;
an optical waveguide to optically couple the first PIC to the second PIC; and
an optical switch on the optical waveguide between the first PIC and the second PIC, wherein the optical switch comprises an optical phase change material.

12. The optical communication system of claim 11, further comprising:
a third PIC, wherein the third PIC is communicatively coupled to the first PIC and the second PIC.

13. The optical communication system of claim 12, further comprising:
a second optical switch between the third PIC and the first PIC, wherein the second optical switch comprises an optical phase change material.

14. The optical communication system of claim 13, wherein the optical switch and the second optical switch are configured to be in opposite states.

15. The optical communication system of claim 11, wherein the optical switch is over at least one surface of the optical waveguide.

16. The optical communication system of claim 11, wherein the optical switch is over at least two surfaces of the optical waveguide.

17. The optical communication system of claim 11, wherein the optical switch is switched between an on state and an off state using an optical signal, applying thermal energy to the optical phase change material, or applying an electric field to the optical phase change material.

18. The optical communication system of claim 11, wherein the optical waveguide is over a glass substrate.

19. The optical communication system of claim 11, wherein the optical communication system is part of an electronic package.

20. An electronic package, comprising:
a core, wherein the core comprises glass;
an optical waveguide provided on the core, wherein the optical waveguide has a first branch and a second branch;
a first optical switch on the first branch and a second optical switch on the second branch, wherein the optical switches each comprise:
an optical phase change material that is in direct contact with the optical waveguide;
a first component at a first end of the optical waveguide;
a second component at a second end of the optical waveguide along the first branch; and
a third component at the second end of the optical waveguide along the second branch.

21. The electronic package of claim 20, wherein the first component is a photonics integrated circuit (PIC).

22. The electronic package of claim 20, wherein the electronic package is coupled to a board, and wherein a die is coupled to the electronic package.

23. A computing system, comprising:
a board;
a package substrate coupled to the board, wherein the package substrate comprises:
a core, wherein the core comprises glass;
an optical waveguide network on the core; and
an optical switch on the optical waveguide network, wherein the optical switch comprises an optical phase change material; and
a die coupled to the package substrate.

24. The computing system of claim 23, wherein the die comprises a photonics integrated circuit (PIC).

25. The computing system of claim 23, wherein the optical phase change material comprises germanium, antimony, and tellurium, or germanium, antimony, selenium, and tellurium, or antimony and sulfur, or antimony and selenium.
